(19) United States
(12) Patent Application Publication
(10) Pub. No.: US 2004/0151829 A1
(43) Pub. Date: Aug. 5, 2004

(54) Optimizing OLED emission

(75) Inventors: Michael L. Boroson, Rochester, NY (US); Lee W. Tutt, Webster, NY (US); Myron W. Culver, Rochester, NY (US)

Correspondence Address: Thomas H. Close, Eastman Kodak Company, 343 State Street, Rochester, NY, 14650-2201, US

(73) Assignee: Eastman Kodak Company

(21) Appl. No.: 10/356,118

(22) Filed: Jan. 31, 2003

(51) Int. Cl. B05D 5/06

(52) U.S. Cl. 427/64; 427/68

(57) ABSTRACT

A method of forming a colored organic light-emitting device comprising: providing an anode and a cathode; forming at least one emissive layer for producing a predetermined colored light between the anode and cathode; forming at least one organic layer in relationship to the emissive layer by selectively transferring organic material from at least one donor element; and varying the thickness of the organic layer to produce effective colored light produced by the emissive layer for the organic light-emitting device.

### CROSS REFERENCE TO RELATED APPLICATIONS

Reference is made to commonly assigned U.S. patent application Ser. No. 10/060,837 filed Jan. 30, 2002 by Mitchell Burberry et al., entitled “Using Spacer Elements to Make Electroluminescent Display Devices”, the disclosure of which is herein incorporated by reference.

### FIELD OF THE INVENTION

The present invention relates to a method for making organic electroluminescent (EL) devices, also known as organic light-emitting diodes (OLED).

### BACKGROUND OF THE INVENTION

In color or full-color organic electroluminescent (EL) displays (also known as organic light-emitting diode devices, or OLED devices) having an array of colored pixels such as red, green, and blue color pixels (commonly referred to as RGB pixels), precision patterning of the color-producing organic EL media are required to produce the RGB pixels, or a pattern of RGB color filters or color change modules are required in combination with a single common emitting color. The basic OLED device has in common an anode, a cathode, and an organic EL medium sandwiched between the anode and the cathode. The organic EL medium can consist of one or more layers of organic thin films, where one or more of the layers is/are primarily responsible for light generation or electroluminescence. This particular layer(s) is/are generally referred to as the emissive layer(s) of the organic EL medium. Other organic layers present in the organic EL medium can provide electronic transport functions primarily and are referred to as either the hole transport layer (for hole transport) or electronic transport layer (for electron transport). In forming separate emitting RGB pixels in a full-color OLED display panel, it is necessary to devise a method to precisely pattern the emissive layer(s) of the organic EL medium, the entire organic EL medium, or some subset of the organic medium. In forming the RGB pixels in a full-color OLED display panel using color filters or color change modules, it is not required to precisely pattern the emissive layer(s), the entire organic EL medium, or some subset thereof.

However, tuning of the single emitting color to match RGB color filters or color change modules would require precisely patterning the emissive layer(s), the entire organic EL medium, or some subset thereof.

Typically, electroluminescent pixels are formed on the display by shadow masking techniques such as shown in U.S. Pat. No. 5,742,129. Although this has been effective, it has several drawbacks. It has been difficult to achieve high resolution of pixel sizes using shadow masking. Moreover, there are problems of alignment between the substrate and the shadow mask, and care must be taken that pixels are formed in the appropriate locations. When it is desirable to increase the substrate size, it is difficult to manipulate the shadow mask to form appropriately positioned pixels.

Donor materials have been known for many years for the purpose of laser thermal dye transfer of images as taught in U.S. Pat. No. 4,772,582 and references therein. The process uses donor sheets to transfer different colors using a laser beam to heat up and thermally transfer dyes from the donor to the receiver. This method is used for high quality images but does not teach the transfer of EL materials.

A suitable method for patterning high-resolution OLED displays has been disclosed in U.S. Pat. No. 5,851,709 by Grande et al. This method is comprised of the following sequences of steps: 1) providing a substrate having opposing first and second surfaces; 2) forming a light-transmissive heat-insulating layer over the first surface of the substrate; 3) forming a light-absorbing layer over the heat-insulating layer; 4) providing the substrate with an array of openings extending from the second surface to the heat-insulating layer; 5) providing a transferable color-forming organic donor layer formed on the light-absorbing layer; 6) precision aligning the donor substrate with the display substrate in an oriented relationship between the openings in the substrate and the corresponding color pixels on the device; and 7) employing a source of radiation for producing sufficient heat at the light-absorbing layer over the openings to cause the transfer of the organic layer on the donor substrate to the display substrate. A problem with the Grande et al. approach is that patterning of an array of openings on the donor substrate is required. Another problem is that the requirement for precision mechanical alignment between the donor substrate and the display substrate. A further problem is that the donor pattern is fixed and cannot be changed readily.

Littman and Tang (U.S. Pat. No. 5,688,551) teach the patternwise transfer of organic EL material from an unpatterned donor sheet to an EL substrate. A series of patents by Wolk et al. (U.S. Pat. Nos. 6,114,088; 6,140,009; 6,214,520; and 6,221,553) teach a method that can transfer the luminescent layer of an EL device from a donor element to a substrate by heating selected portions of the donor with a laser beam. Each layer is an operational or non-operational layer that is utilized in the function of the device.

Such OLED devices generally include layers other than emissive layers, such as hole-transporting layers and electron-transporting layers. Such layers are generally put uniformly on OLED devices. Fukuda et al., in Synthetic Metals 111-112 (2000) 1-6, and Oh et al. in Society for Information Display, 2002 International Symposium, Digest of Technical Papers, Volume XXXIII, Number II (2002) 1271-1273, have shown that varying the thickness of these layers can affect the quality of emissions, and that different color OLED devices can have different optimum thicknesses. Manufacturing full-color devices with different layer thicknesses for each color will be difficult with shadow masks common in the art.

### SUMMARY OF THE INVENTION

It is therefore an object of the present invention to allow deposition of variable thicknesses of emitting and non-emitting layers of an OLED device in a manner, which can be manufactured on a large scale. It is also an object of this invention to give improved performance from each color emission in a color OLED device through the use of this invention.

This object is achieved by a method of forming a colored organic light-emitting device comprising:

a) providing an anode and a cathode;

b) forming at least one emissive layer for producing a predetermined colored light between the anode and cathode;

c) forming at least one organic layer in relationship to the emissive layer by selectively transferring organic material from at least one donor element; and

d) varying the thickness of the organic layer formed in Step c) to produce effective colored light produced by the emissive layer for the organic light-emitting device.

This object is also achieved by a method of forming a colored organic light-emitting device comprising:

a) providing an anode and a cathode;

b) forming a plurality of emissive layers by selectively transferring from first donor elements different-colored light-producing materials between the anode and cathode;

c) forming at least one organic layer in relationship to the emissive layers by selectively transferring organic material from at least one second donor element; and

d) varying the thickness of the emissive layer or the organic layer(s) or both formed in Steps b) and c) for each different-colored emissive layer to produce effective colors for the organic light-emitting device.

### Advantages

An advantage of the present invention is that it allows various layers of an OLED device to be precisely tuned for optimum performance of individual pixels by varying the thickness of component layers. A further advantage is that the need for a shadow mask in producing such various thickness layers and all the problems inherent in the use of such a shadow mask are eliminated.

### BRIEF DESCRIPTION OF THE DRAWINGS

FIG. 1 shows a plan view of a substrate prepared in accordance with this invention;

FIG. 2a shows a cross-sectional representation of the structure of an example OLED device;

FIG. 2b shows a cross-sectional representation of the structure of another example OLED device;

FIG. 3 shows a cross-sectional representation of the transfer of organic material from donor to substrate by one method of treatment with light;

FIG. 4a shows a cross-sectional representation of an OLED substrate in which selected pixels have been treated with an organic material;

FIG. 4b shows a cross-sectional representation of the OLED substrate from FIG. 4a in which further selected pixels have been treated with the same organic material;

FIG. 4c shows a cross-sectional representation of the OLED substrate from FIG. 4b in which all pixels have been treated with the same organic material;

FIG. 5 shows a cross-sectional representation of the OLED substrate from FIG. 4b in which the entire surface has been treated with the same organic material;

FIG. 6 shows a cross-sectional representation of an OLED substrate in which multiple selected pixels have been treated with an organic material;

FIG. 7 is a block diagram showing the steps involved in practicing one embodiment of this invention;

FIG. 8 is a block diagram showing the steps involved in practicing another embodiment of this invention;

FIG. 9 is a block diagram showing the steps involved in practicing another embodiment of this invention.

Since device feature dimensions such as layer thicknesses are frequently in sub-micrometer ranges, the drawings are scaled for ease of visualization rather than dimensional accuracy.

### DETAILED DESCRIPTION OF THE INVENTION

The term “display” or “display panel” is employed to designate a screen capable of electronically displaying video images or text. The term “pixel” is employed in its art-recognized usage to designate an area of a display panel that can be stimulated to emit light independently of other areas. The term “OLED device” or “organic light-emitting device” is used in its art-recognized meaning of a display device comprising organic light-emitting diodes as pixels. A colored organic light-emitting device produces light of at least two colors. The term “multicolor” is employed to describe a display panel that is capable of producing light of a different hue in different areas. In particular, it is employed to describe a display panel that is capable of displaying images of different colors. These areas are not necessarily contiguous. The term “full color” is employed to describe multicolor display panels capable of displaying images in any combination of hues, e.g. capable of emitting in the red, green, and blue regions of the visible spectrum, emitting white light with an RGB color filter array, or emitting blue light with an RGB color change module. The red, green, and blue colors constitute the three primary color from which all other colors can be generated by appropriately mixing these three primaries. The term “hue” refers to the intensity profile of light emission within the visible spectrum, with different hues exhibiting visually discernible differences in color. The pixel or subpixel is generally used to designate the smallest addressable unit in a display panel. For a monochrome display, there is no distinction between pixel or subpixel. The term “subpixel” is used in multicolor display panels and is employed to designate any portion of a pixel, which can be independently addressable to produce a specific color. For example, a blue subpixel is that portion of a pixel, which can be addressed to produce blue light. In a full-color display, a pixel generally comprises three primary-color subpixels, namely blue, green, and red. The term “pitch” is used to designate the distance separating two pixels or subpixels in a display panel. Thus, a subpixel pitch means the separation between two subpixels.

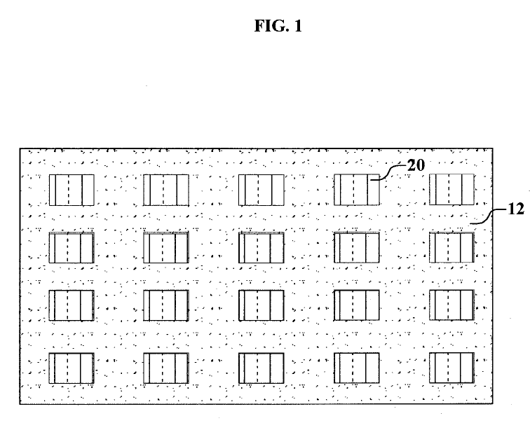

Turning now to FIG. 1, there is shown a plan view of substrate 12, which can be treated in the manner described in this invention. Substrate 12 can be an organic solid, an inorganic solid, or a combination of organic and inorganic solids that provides a surface for receiving the emissive material from a donor and can be rigid or flexible. Typical substrate materials include glass, plastic, metal, ceramic, semiconductor, metal oxide, semiconductor oxide, semiconductor nitride, or combinations thereof. Substrate 12 can be a homogeneous mixture of materials, a composite of materials, or multiple layers of materials. Substrate 12 can be an OLED substrate, that is, a substrate commonly used for preparing OLED devices, e.g. active-matrix low-temperature polysilicon TFT substrate that can include thin-film transistors 20 at the locations of pixels in the OLED device. The substrate 12 can either be light transmissive or opaque, depending on the intended direction of light emission. The light transmissive property is desirable for viewing the EL emission through the substrate. Transparent glass or plastic are commonly employed in such cases. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, ceramics, and circuit board materials, or any others commonly used in the formation of OLED devices, which can be either passive-matrix devices or active-matrix devices. Substrate 12 can be coated with other layers.

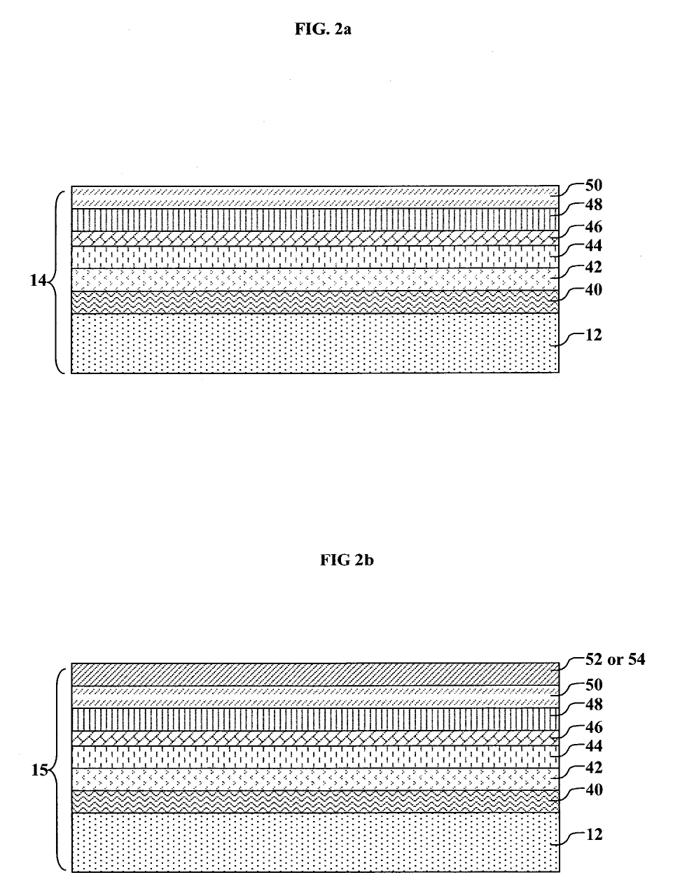

Turning now to FIG. 2a, there is shown in cross-sectional view an example of the structure of the emissive portion of an OLED device. For a multicolor OLED device, FIG. 2 represents a subpixel of a single hue. OLED device 14 is formed on substrate 12, which is coated in the region of interest with anode 40. The conductive anode layer is formed over the substrate and, when EL emission is viewed through the anode, should be transparent or substantially transparent to the emission of interest. Common transparent anode materials used in this invention are indium-tin oxide and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as an anode material. For applications where EL emission is viewed through the top electrode, the transmissive characteristics of the anode material are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials can be deposited by any suitable means such as evaporation, sputtering, chemical vapor deposition, or electrochemical means. Anode materials can be patterned using well known photolithographic processes.

OLED device 14 further includes cathode 50. When light emission is through the anode, the cathode material can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprised of a thin layer of a low work function metal or metal salt capped with a thicker layer of conductive metal. One such cathode is comprised of a thin layer of LiF followed by a thicker layer of Al as described in U.S. Pat. No. 5,677,572. Other useful cathode materials include, but are not limited to, those disclosed in U.S. Pat. Nos. 5,059,861; 5,059,862; and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 5,776,623. Cathode materials can be deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser transfer, and selective chemical vapor deposition.

OLED device 14 can further include hole-injecting layer 42 between anode 40 and cathode 50. While not always necessary, it is often useful that a hole-injecting layer be provided in an organic light-emitting display. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, and plasma-deposited fluorocarbon polymers as described in U.S. Pat. No. 6,208,075. Alternative hole-injecting materials reportedly useful in organic EL devices are described in EP 0 891 121 A1 and EP 1,029,909 A1.

OLED device 14 further includes hole-transporting layer 44, which can include any hole-transporting materials, between anode 40 and cathode 50. Desired hole-transporting materials can be deposited by any suitable means such as evaporation, sputtering, chemical vapor deposition, or electrochemical means. Hole-transporting materials can be patterned using well known photolithographic processes.

Hole-transporting materials are well known to include compounds such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al. U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural Formula (A).

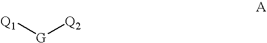

wherein:

Q₁ and Q₂ are independently selected aromatic tertiary amine moieties; and

G is a linking group such as an arylene, cycloalkylene, or alkylene group of a carbon to carbon bond.

In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural Formula (A) and containing two triarylamine moieties is represented by structural Formula (B):

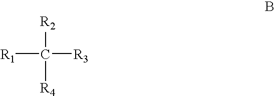

where R₁ and R₂ each independently represents a hydrogen atom, an aryl group, or an alkyl group or R₁ and R₂ together represent the atoms completing a cycloalkyl group; and

R₃ and R₄ each independently represents an aryl group, which is in turn substituted with a diaryl substituted amino group, as indicated by structural Formula (C):

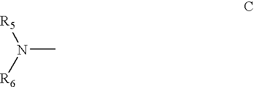

wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by Formula (C), linked through an arylene group. Useful tetraaryldiamines include those represented by Formula (D).

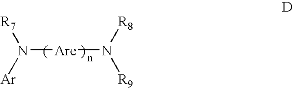

wherein:

each Are is an independently selected arylene group, such as a phenylene or anthracene moiety;

n is an integer of from 1 to 4; and

Ar, R₇, R₈, and R₉ are independently selected aryl groups.

In a typical embodiment, at least one of Ar, R₇, R₈, and R₉ is a polycyclic fused ring structure, e.g., a naphthalene.

The various alkyl, alkylene, aryl, and arylene moieties of the foregoing structural Formulae (A), (B), (C), (D), can each in turn be substituted. Typical substituents include alkyl groups, alkoxy groups, aryl groups, aryloxy groups, and halogen such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms—e.g., cyclopentyl, cyclohexyl, and cycloheptyl ring structures. The aryl and arylene moieties are usually phenyl and phenylene moieties.

The hole-transporting layer can be formed of a single or a mixture of aromatic tertiary amine compounds. Specifically, one can employ a triarylamine, such as a triarylamine satisfying the Formula (B), in combination with a tetraaryldiamine, such as indicated by Formula (D). When a triarylamine is employed in combination with a tetraaryldiamine, the latter is positioned as a layer interposed between the triarylamine and the electron injecting and transporting layer. Illustrative of useful aromatic tertiary amines are the following:

1,1-Bis(4-di-p-tolylaminophenyl)cyclohexane

1,1-Bis(4-di-p-tolylaminophenyl)-4-phenylcyclohexane

4,4′-Bis(diphenylamino)quadriphenyl

Bis(4-dimethylamino-2-methylphenyl)-phenylmethane

N,N,N-Tri(p-tolyl)amine

4-(di-p-tolylamino)-4′-[4(di-p-tolylamino)-styryl]stilbene

N,N,N′,N′-Tetra-p-tolyl-4-4′-diaminobiphenyl

N,N,N′,N′-Tetraphenyl-4,4′-diaminobiphenyl

N-Phenylcarbazole

Poly(N-vinylcarbazole)

N,N′-di-1-naphthalenyl-N,N′-diphenyl-4,4′-diaminobiphenyl

4,4′-Bis[N-(1-naphthyl)-N-phenylamino]biphenyl

4,4″-Bis[N-(1-naphthyl)-N-phenylamino]p-terphenyl

4,4′-Bis[N-(2-naphthyl)-N-phenylamino]biphenyl

4,4′-Bis[N-(3-acenaphthenyl)-N-phenylamino]biphenyl

1,5-Bis[N-(1-naphthyl)-N-phenylamino]naphthalene

4,4′-Bis[N-(9-anthryl)-N-phenylamino]biphenyl

4,4″-Bis[N-(1-anthryl)-N-phenylamino]-p-terphenyl

4,4′-Bis[N-(2-phenanthryl)-N-phenylamino]biphenyl

4,4′-Bis[N-(8-fluoranthenyl)-N-phenylamino]biphenyl

4,4′-Bis[N-(2-pyrenyl)-N-phenylamino]biphenyl

4,4′-Bis[N-(2-naphthacenyl)-N-phenylamino]biphenyl

4,4′-Bis[N-(2-perylenyl)-N-phenylamino]biphenyl

4,4′-Bis[N-(1-coronenyl)-N-phenylamino]biphenyl

2,6-Bis(di-p-tolylamino)naphthalene

2,6-Bis[di-(1-naphthyl)amino]naphthalene

2,6-Bis[N-(1-naphthyl)-N-(2-naphthyl)amino]naphthalene

N,N,N′,N′-Tetra(2-naphthyl)-4,4″-diamino-p-terphenyl

4,4′-Bis {N-phenyl-N-[4-(1-naphthyl)-phenyl]amino}biphenyl

4,4′-Bis[N-phenyl-N-(2-pyrenyl)amino]biphenyl

2,6-Bis[N,N-di(2-naphthyl)amine]fluorene

1,5-Bis[N-(1-naphthyl)-N-phenylamino]naphthalene

Another class of useful hole-transport materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

OLED device 14 further includes one or more emissive layer(s) 46, also known as organic emissive layer(s), for producing a predetermined colored light and formed between anode 40 and cathode 50. Emissive layer 46 can be deposited by evaporation, spin coating, inkjet techniques, thermal transfer, or the techniques of this invention. Depending on the requirements of OLED device 14, emissive layer 46 can include more than one emissive layer. A full-color OLED device can include a plurality of such emissive layers, e.g. emissive layers that have emission spectra in the red, green, and blue regions of the visible spectrum. Alternatively, a full-color OLED device can include one or more common emissive layers with a color filter array or an array of color change modules disposed in operative relationship with the colored organic light-emitting device and adapted to receive colored light from the emissive layer so as to create a multicolor OLED device with a common emissive layer. Useful organic emissive materials, also called light-producing materials, are well known. As more fully described in U.S. Pat. Nos. 4,769,292 and 5,935,721, the light-emitting layer (LEL) of the organic EL element comprises a light-producing material where electroluminescence is produced as a result of electron-hole pair recombination in this region. The emissive layer can be comprised of a single material, but more commonly comprises one or more host material(s) doped with a guest compound or compounds where light emission comes primarily from the dopant material and can be of any color. The host materials in the light-emitting layer can be an electron-transporting material, as described below, a hole-transporting material, as previously described, or another material that supports hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight relative to the host material. The dopants can be different-colored light-producing materials that can have an emission spectrum in the blue region of the visible spectrum, the green region of the visible spectrum, or the red region of the visible spectrum, or any other region.

An important relationship for choosing a dye as a dopant material is a comparison of the bandgap potential which is defined as the energy difference between the highest occupied molecular orbital and the lowest unoccupied molecular orbital of the molecule. For efficient energy transfer from the host material to the dopant molecule, a necessary condition is that the band gap of the dopant is smaller than that of the host material. Host and emitting molecules known to be of use include, but are not limited to, those disclosed in U.S. Pat. Nos. 4,768,292; 5,141,671; 5,150,006; 5,151,629; 5,294,870; 5,405,709; 5,484,922; 5,593,788; 5,645,948; 5,683,823; 5,755,999; 5,928,802; 5,935,720; 5,935,721; and 6,020,078.

Derivatives of 9,10-di-(2-naphthyl)anthracene (Formula E) constitute one class of useful host materials capable of supporting electroluminescence, and are particularly suitable for light emission of wavelengths longer than 400 nm, e.g., blue, green, yellow, orange or red.

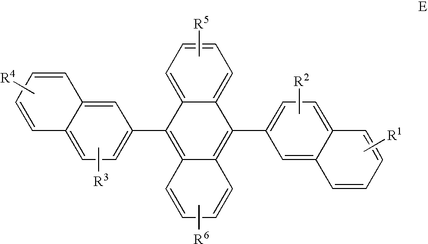

wherein R¹, R², R³, R⁴, R⁵, and R⁶ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of anthracenyl; pyrenyl, or perylenyl;

Group 4: heteroaryl or substituted heteroaryl of from 5 to 24 carbon atoms as necessary to complete a fused heteroaromatic ring of furyl, thienyl, pyridyl, quinolinyl or other heterocyclic systems;

Group 5: alkoxylamino, alkylamino, or arylamino of from 1 to 24 carbon atoms; and

Group 6: fluorine, chlorine, bromine or cyano.

Benzazole derivatives (Formula F) constitute another class of useful hosts capable of supporting electroluminescence, and are particularly suitable for light emission of wavelengths longer than 400 nm, e.g., blue, green, yellow, orange or red.

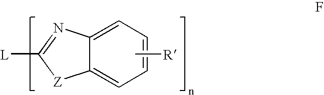

where:

n is an integer of 3 to 8;

Z is O, N or S;

R′ is hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and

L is a linkage unit consisting of alkyl, aryl, substituted alkyl, or substituted aryl, which conjugately or unconjugately connects the multiple benzazoles together.

An example of a useful benzazole is 2,2′,2″-(1,3,5-phenylene)tris[1-phenyl-1H-benzimidazole].

Desirable fluorescent dopants include derivatives of anthracene, tetracene, xanthene, perylene, rubrene, coumarin, rhodamine, quinacridone, dicyanomethylenepyran compounds, thiopyran compounds, polymethine compounds, pyrilium and thiapyrilium compounds, and carbostyryl compounds. Illustrative examples of useful dopants include, but are not limited to, the following:

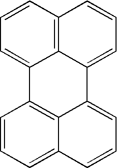

L1

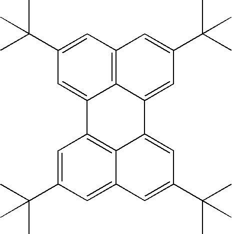

L2

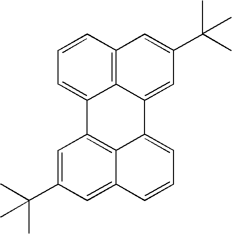

L3

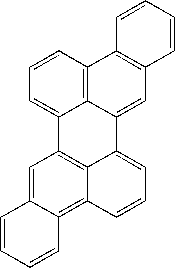

L4

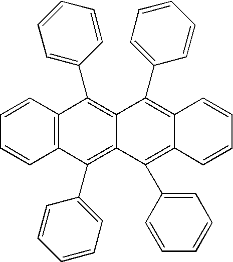

L5

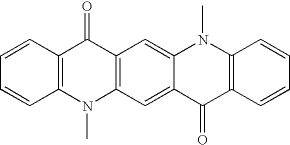

L6

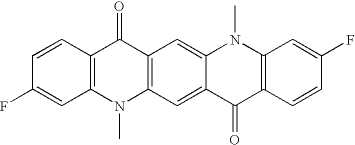

L7

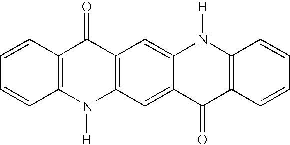

L8

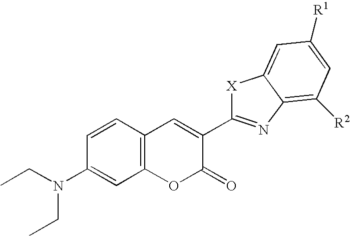

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |

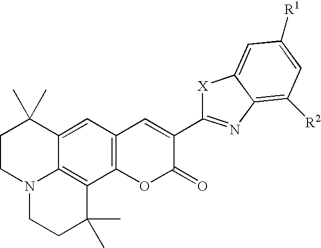

| | X | R1 | R2 |
|---|---|---|---|
| L23 | O | H | H |
| L24 | O | H | Methyl |
| L25 | O | Methyl | H |
| L26 | O | Methyl | Methyl |
| L27 | O | H | t-butyl |
| L28 | O | t-butyl | H |
| L29 | O | t-butyl | t-butyl |
| L30 | S | H | H |
| L31 | S | H | Methyl |
| L32 | S Methyl | H | |
| L33 | S | Methyl | Methyl |
| L34 | S | H | t-butyl |
| L35 | S | t-butyl | H |
| L36 | S | t-butyl | t-butyl |

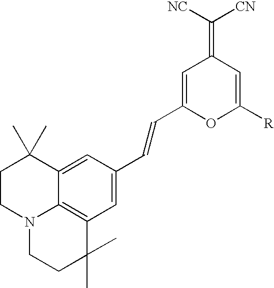

| | R |
|---|---|
| L37 | phenyl |
| L38 | methyl |
| L39 | t-butyl |
| L40 | mesityl |

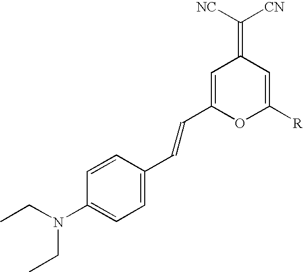

| | R |
|---|---|
| L41 | phenyl |
| L42 | methyl |
| L43 | t-butyl |
| L44 | mesityl |

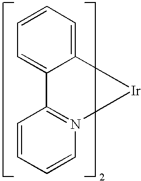

L45

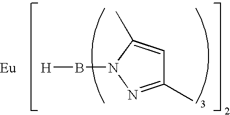

L46

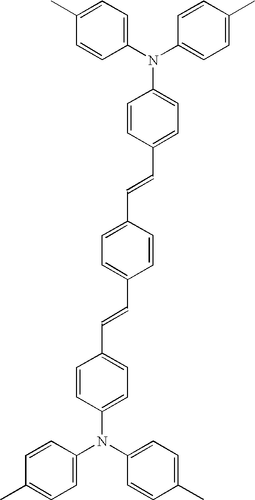

L47

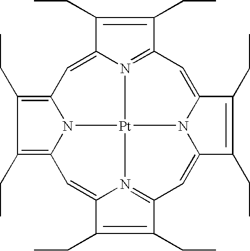

L48

Other organic emissive materials can be polymeric substances, e.g. polyphenylenevinylene derivatives, dialkoxy-polyphenylenevinylenes, poly-paraphenylene derivatives, and polyfluorene derivatives, as taught by Wolk et al. in commonly assigned U.S. Pat. No. 6,194,119 B1 and references therein.

OLED device 14 further includes electron-transporting layer 48 formed between anode 40 and cathode 50. Desired electron-transporting materials can be deposited by any suitable means such as evaporation, sputtering, chemical vapor deposition, or electrochemical means. Electron-transporting materials can be patterned using well known photolithographic processes. Preferred electron-transporting materials for use in organic EL devices of this invention are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films.

Electron transporting materials include metal complexes of 8-hydroxyquinoline and similar derivatives (Formula G), which can also constitute one class of useful host compounds capable of supporting electroluminescence, particularly suitable for light emission of wavelengths longer than 500 nm, e.g., green, yellow, orange, and red.

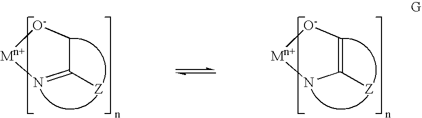

wherein:

M represents a metal;

n is an integer of from 1 to 3; and

Z independently in each occurrence represents the atoms completing a nucleus having at least two fused aromatic rings.

From the foregoing it is apparent that the metal can be monovalent, divalent, or trivalent metal. The metal can, for example, be an alkali metal, such as lithium, sodium, or potassium; an alkaline earth metal, such as magnesium or calcium; or an earth metal, such as boron or aluminum. Generally any monovalent, divalent, or trivalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:

CO-1: Aluminum trisoxine [alias, tris(8-quinolinolato)aluminum(III)]

CO-2: Magnesium bisoxine [alias, bis(8-quinolinolato)magnesium(II)]

CO-3: Bis[benzo{f}-8-quinolinolato]zinc (II)

CO-4: Bis(2-methyl-8-quinolinolato)aluminum(III)-μ-oxo-bis(2-methyl-8-quinolinolato) aluminum(III)

CO-5: Indium trisoxine [alias, tris(8-quinolinolato)indium]

CO-6: Aluminum tris(5-methyloxine) [alias, tris(5-methyl-8-quinolinolato) aluminum(III)]

CO-7: Lithium oxine [alias, (8-quinolinolato)lithium(I)]

Other electron-transporting materials include various butadiene derivatives as disclosed in U.S. Pat. No. 4,356,429 and various heterocyclic optical brighteners as described in U.S. Pat. No. 4,539,507. Benzazoles satisfying structural Formula (F) are also useful electron-transporting materials.

Other electron-transporting materials can be polymeric substances, e.g. polyphenylenevinylene derivatives, poly-para-phenylene derivatives, polyfluorene derivatives, polythiophenes, polyacetylenes, and other conductive polymeric organic materials such as those listed in commonly assigned U.S. Pat. No. 6,221,553 B1 and references therein.

Other layers not shown in this embodiment are sometimes useful in OLED devices. For example, an electron-injecting layer can be deposited between the cathode 50 and the electron-transporting layer 48. Examples of electron-injecting materials include alkali halide salts, such as LiF.

Many of the layers of OLED device 14 are commonly deposited in the art through methods that lead to uniform laydown, e.g. sputtering or vaporization transfer from a heated boat, which leads to relatively uniform layer thickness across the surface of the OLED device. This is not always desirable, as both Fukuda et al. and Oh et al. have shown. This invention comprises a method of forming a colored organic light-emitting device, such as OLED device 14, that includes providing anode 40 and cathode 50, and forming one or more emissive layers (such as emissive layer 46). Emissive layer(s) 46 can be deposited by a method of uniform laydown, or by selectively transferring from first donor elements different-colored light-producing materials between anode 40 and cathode 50. The choice of deposition method will in part be determined by the desired properties of emissive layer(s) 46. The method further includes forming at least one organic layer (e.g. hole-injecting layer 42, hole-transporting layer 44, electron-transporting layer 48, an electron-injecting layer, or an additional emissive layer) in relationship to emissive layer(s) 46 by selective transfer of organic material from one or more donor elements whose nature will become evident. The method further includes varying the thickness of emissive layer(s) 46, or one or more of the organic layers described above, or both. The thickness of emissive layer(s) 46 or the various other organic layers can be varied for each different-colored emissive layer so as to produce effective colors for the organic light-emitting device. By “effective color” or “effective colored light” it is meant the best combination of color properties, e.g. hue, intensity, purity, saturation, or any other properties of color deemed desirable. The thicknesses of the layers of a given color pixel are optimized to produce effective colored light. That is, all red subpixels can have a set of predetermined thicknesses for the various layers, all green subpixels can have a different set of predetermined thicknesses, etc.

This technique can be applied to pixels that emit different colors, to a white-emitting layer tuned for-different colors of a color filter array, or to a blue-emitting tuned for different colors of a color change module array. In particular, this technique can be used to maximize the light emitted by an OLED device. In a typical OLED device, the emitted light is viewed through one side. For example, a common structure is a bottom-emitting OLED device with a transparent anode 40 and a highly reflective cathode 50. Light produced by emissive layer 46 in the direction of cathode 50 can be reflected and thereby emitted through anode 40. It is well known that the reflected light will optically interfere with the light emitted by emissive layer 46 in the direction of anode 40. It is therefore desirable to maximize emitted light by optimizing the thickness of the intervening layers, e.g. electron-transporting layer 48, to cause the optical interference to be constructive. In order to control the type of optical interference, the thickness of the layers between the point of emission and the point of reflection needs to be equal to an integral multiple of one-half the wavelength with adjustment for any phase shift that occurs due to the reflection. This relationship is given by equation 1:

$$d = ( N + \frac{{θ}_{Shift}}{2 π} ) \times \frac{λ}{2 n} \qquad Equation 1$$

where d is the layer thickness, N is an integer number, n is the refractive index of the layer, θ is the phase shift which occurs at point of reflection, and λ is the principle wavelength of concern. Given the existence of multiple layers with different refractive indices, equation 2 can be used:

$$\frac{2}{λ} ( \sum {d}_{1} {n}_{1} + {d}_{2} {n}_{2} + … ) - \frac{{θ}_{Shift}}{2 π} = N \qquad Equation 2$$

where d₁n₁ is the thickness and refractive index of the first layer, d₂n₂ is the thickness and refractive index of the second layer, etc. The final combination of the thickness used should result in an integer number N in equation 2. It is, of course, difficult to deposit the various layers such that N will be exactly an integer. It is sufficient for this invention that N be an integer ±0.25, and preferable an integer ±0.1.

For the purposes of this invention, the term “organic layer” can refer to any or all of hole-injecting layer 42, hole-transporting layer 44, electron-transporting layer 48, an electron-injecting layer, or additional emissive layers, or any combinations thereof. The organic layers are found in relationship to emissive layer 46, that is, they are disposed above or below emissive layer 46.

Turning now to FIG. 2b, there is shown in cross-sectional view another example of the structure of the emissive portion of an OLED device. OLED device 15 is formed as OLED device 14 was, with the addition of either a color filter 52 or a color change module 54. These impart desired properties to the light produced by OLED device 15. For example, emissive layer 46 can produce white light, and color filter 52 can be e.g. a red, green, or blue filter to permit only a desired color to pass and be seen by the viewer. As another example, emissive layer 46 can produce blue light and color change module 54 can absorb the blue light and produce e.g. green or red light. Color change module 54 can be a fluorescent or phosphorescent material with an absorption maximum near the emission wavelength of emissive layer 46.

It will be understood that color filter 52 or color change module 54 can be located as shown or in other positions, for example between electron-transporting layer 48 and cathode 50. In this embodiment, cathode 50 is transparent and the device is a top-emitting device. If the OLED device is a bottom-emitting device, that is if cathode 50 is reflective or opaque, color filter 52 or color change module 54 will be located at or near the bottom of the device, e.g. below substrate 12 or between substrate 12 and anode 40. It will be further understood that in a full-color OLED device, color filter 52 or color change module 54 will be formed in an array, e.g. a color filter array of red, green, and blue color filters 52 can allow a uniform emissive layer 46 to behave as a full-color display.

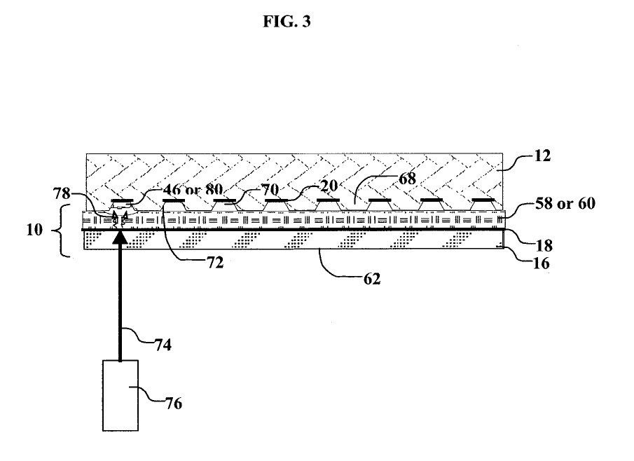

FIG. 3 shows a cross-sectional representation of the process of selectively transferring light-producing material 58 or organic material 60 from donor element 10 to portions of substrate 12 by vaporization transfer in one method of treatment with light. Vaporization transfer is herein defined as any mechanism such as sublimation, ablation, vaporization or other process whereby material can be transferred across a gap. Other methods of transfer and heating can be used such as melt/stick transfer and conductive heating. Donor element 10 has been prepared with light-absorbing layer 18 over donor support element 16. Donor element 10 can represent light-producing material 58, also called an emissive layer, coated on a donor element. Similarly, donor element 10 can represent organic material 60 coated on a donor element.

Donor element 10 is placed in a transfer relationship with substrate 12, which can be an OLED substrate. By transfer relationship, it is meant that donor element 10 is positioned in contact with substrate 12 or is held with a controlled separation from substrate 12. In this embodiment, donor element 10 is in contact with substrate 12 and gap 70 is maintained by the structure of thin-film transistors 20 and intervening raised surface portions 68. Gap 70 has previously been described by commonly assigned U.S. patent application Ser. No. 10/060,837 filed Jan. 30, 2002 by Mitchell Burberry et al., entitled “Using Spacer Elements to Make Electroluminescent Display Devices”, the disclosure of which is herein incorporated by reference. Laser source 76 selectively illuminates non-transfer surface 62 of donor element 10 with laser light 74. Laser source 76 can be e.g. an infrared laser of a power, which is sufficient to cause enough heat 78 to be formed to effect the transfer described herein. Light-absorbing layer 18 of donor element 10 absorbs laser light 74 and produces heat 78. Some or all of the heated portion of material coated on donor element 10 is sublimed, vaporized, or ablated and thus transferred to receiving surface 72 of substrate 12 in a patterned transfer. In this manner, light-producing material 58 can be selectively transferred to selectively form emissive layer 46. Thus, the vaporization transfer of host materials and dopant materials, which comprise the various layers of light-producing material 58, is effected. Likewise, organic material 60 can be selectively transferred to selectively form organic layer 80.

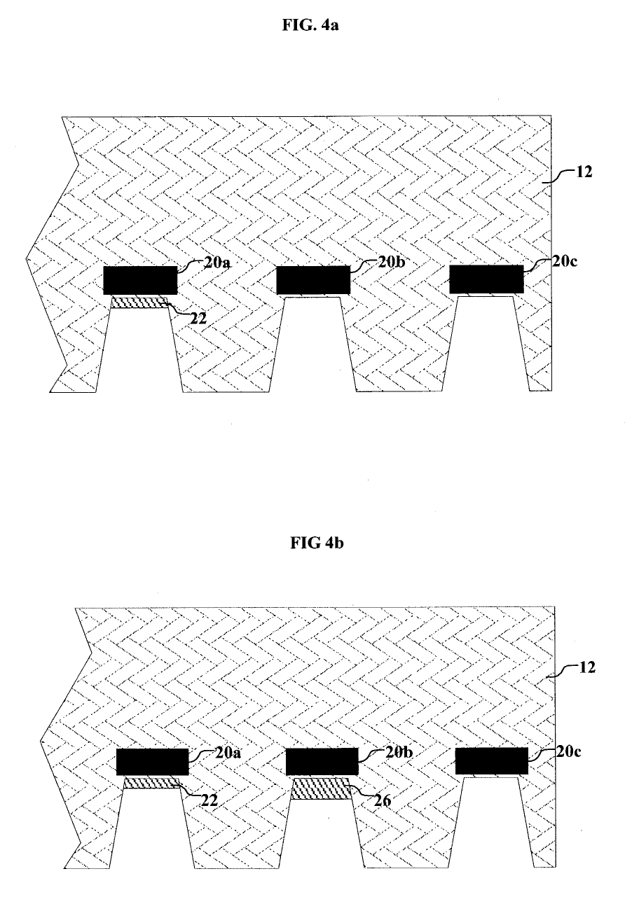

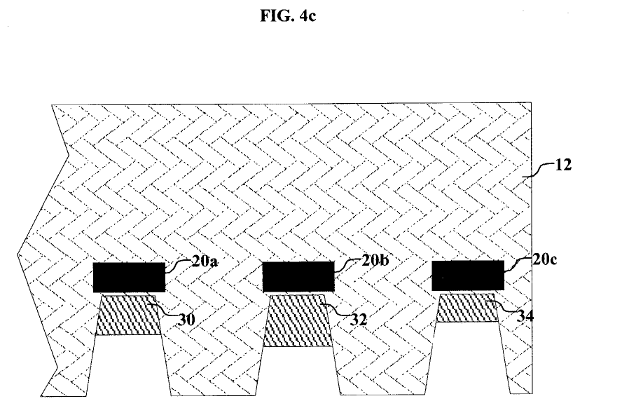

Turning now to FIG. 4a, there is shown a cross-sectional representation of a portion of a substrate 12 of a full-color OLED device. Thin-film transistors 20a, 20b, and 20c form the basis of pixels of different colors, e.g. red, green, and blue. Substrate 12 includes organic material layer 22 that has been deposited, by the method shown in FIG. 3, at all pixels of a first color, e.g. green. Organic material layer 22 can be any non-emissive layer shown in FIG. 2, e.g. hole-transporting layer 44 or electron-transporting layer 48. Other layers among those shown in FIG. 2 can also be present, but are not shown for clarity of illustration. The thickness of organic material layer 22 can be predetermined by, e.g. controlling the thickness of organic material 60 that has been coated onto donor element 10.

Turning now to FIG. 4b, there is shown a cross-sectional representation of substrate 12 from FIG. 4a with the additional treatment of organic material layer 26 that has been deposited, by the method shown in FIG. 3, at all pixels of a second color, e.g. red. Organic material layer 26 comprises the same organic material as organic material layer 22, but at a preferred predetermined thickness for the particular color emitter.

Turning now to FIG. 4c, there is shown a cross-sectional representation of substrate 12 from FIG. 4b with the additional treatment of a uniform layer of organic material, by the method shown in FIG. 3, at all pixels. This results in the formation of organic material layers 30, 32, and 34. The result is a substrate with a different thickness of a given layer for each color pixel.

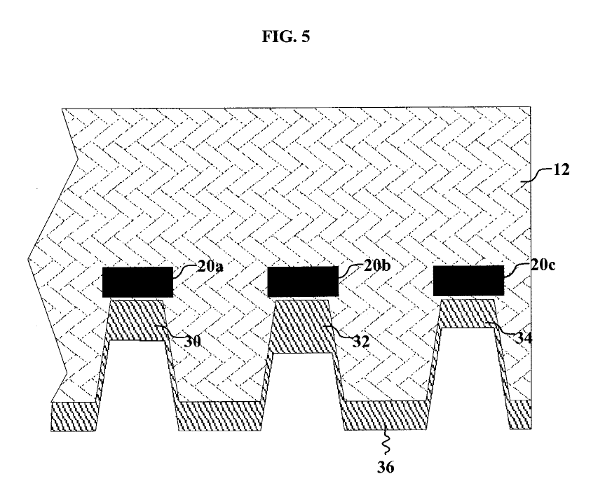

Turning now to FIG. 5, there is shown a cross-sectional representation of substrate 12 from FIG. 4b with the additional treatment of a uniform layer of organic material, by a uniform-deposition method such as sputtering, at all pixels. This results in the formation of organic material layers 30, 32, and 34 with a different thickness of a given layer for each color pixel, and organic material layer 36 between the pixels.

In another embodiment, organic material layers 22 and 26 can be of a different organic material than those subsequently deposited. For example, organic material layers 22 and 26 can comprise a second emissive layer of the same or different composition as the primary emissive layer 46, or the organic material layers 22 and 26 can be a different composition from each other and from the primary emissive layer 46. The further deposition can then comprise material of a different layer, e.g. electron-transporting layer 48. In such a case, one or more of organic material layers 30, 32, and 34 can comprise two or more layers. This can be particularly useful in making full-color OLED displays. In displays with separate red, green, and blue emitters, the optimal organic layer structure is likely to comprise layers of different composition. In displays with a common emitter layer and color filters or color change modules, it is likely that a second emitter layer would be desirable for one or two of the colors but not for all three.

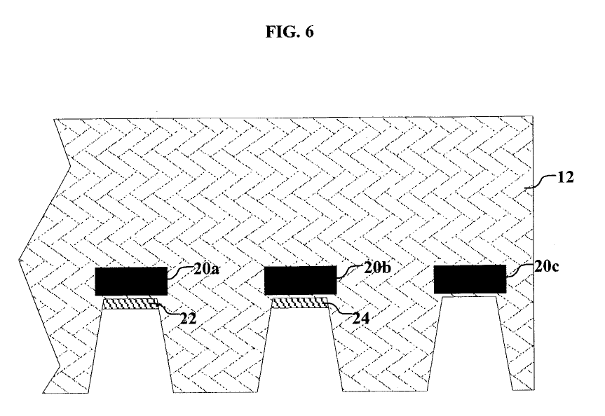

Turning now to FIG. 6, there is shown a cross-sectional representation of a portion of a substrate 12 of a full-color OLED device. Substrate 12 includes organic material layers 22 and 24 that have been deposited, by the method shown in FIG. 3, at all pixels of a first and second color, e.g. red and green. Organic material layers 22 and 24 were deposited to the same thickness. An additional layer of organic material can be deposited over thin-film transistor 20b to form the substrate 12 shown in FIG. 4b.

The organic layers described in this invention can be in a relationship above or below the emissive layer(s), and can be deposited before or after the emissive layer(s). The thickness of the organic layers can be varied by first depositing a common thickness of organic layer, and depositing an additional thickness of the organic layer on selective pixels only. The deposition process can also be reversed—the selective thickness(es) of organic layer can be deposited first, followed by a common thickness of organic layer.

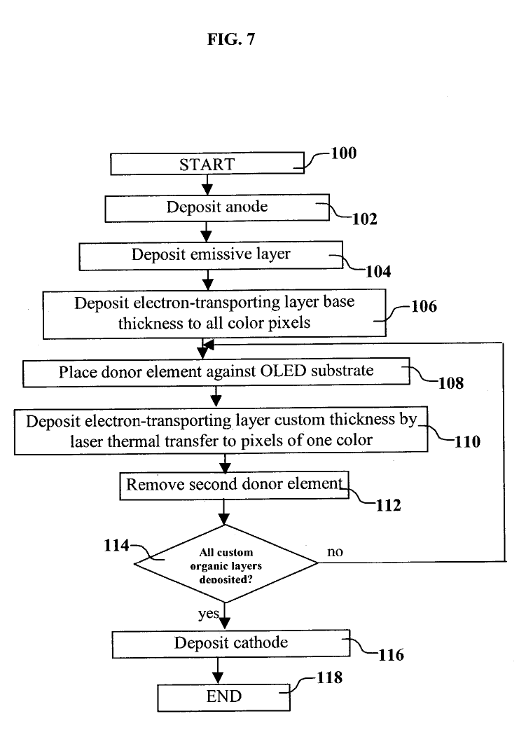

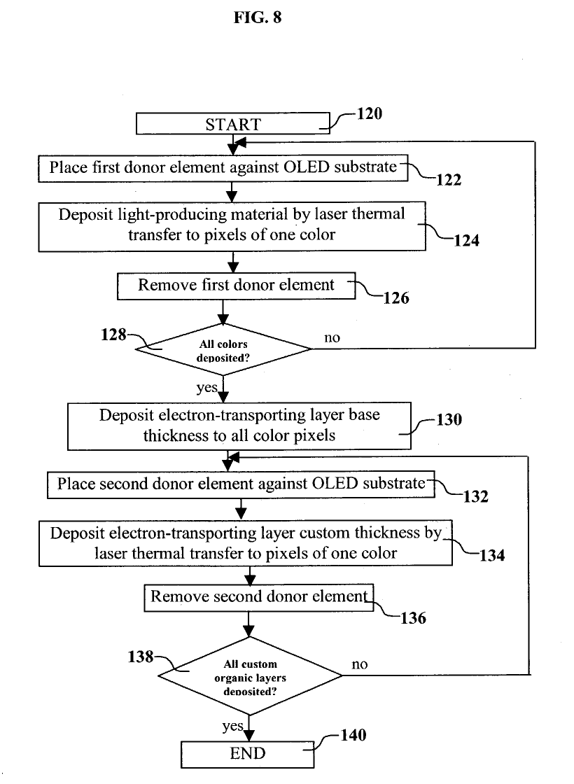

Turning now to FIG. 7, there is shown a block diagram showing the steps involved in practicing one embodiment of this invention. In this embodiment, a varied thickness of electron-transporting material is deposited onto the different-colored pixels of an OLED substrate by first depositing a common thickness onto the pixels, and then depositing differential thicknesses of electron-transporting material onto pixels of one or more different colors. At the start (Step 100), an OLED substrate 12 is prepared with an anode layer 40 (Step 102). The OLED substrate can also optionally include a hole-injecting layer 42, and a hole-transporting layer 44 deposited subsequently. A predetermined thickness of light-producing material is transferred to substrate 12 by any of a variety of methods, such as evaporation, sputtering, chemical vapor deposition, electrochemical means, or laser thermal transfer to form an emissive layer 46 between anode 40 and cathode 50 (Step 104). A predetermined thickness of electron-transporting material is then transferred to all pixels on substrate 12 (Step 106) by any of a variety of methods, such as evaporation, sputtering, chemical vapor deposition, electrochemical means, or laser thermal transfer. A donor element 10 is then placed against OLED substrate 12 (Step 108). A predetermined thickness of electron-transporting material is then transferred from donor element 10 to pixels of a single color (e.g. green) on substrate 12 by illuminating donor element 10 with laser light 74 so that donor element 10 absorbs light and produces heat to selectively form an organic layer in relationship to emissive layer 46, in this case electron-transporting layer 48 above emissive layer 46 and between anode 40 and cathode 50 (Step 110). Because a common thickness of electron-transporting layer 48 was deposited in Step 106, Step 110 varies the thickness of the organic layer, that is, electron-transporting layer 48 over pixels of a single color (e.g. green). The donor element 10 is then removed (Step 112). If a custom thickness of electron-transporting material has not been deposited onto all appropriate pixels (Step 114), Steps 108, 110, and 112 are repeated. If a custom thickness of electron-transporting material has been deposited onto all appropriate pixels (Step 114), a cathode is deposited onto the surface of the OLED substrate 12 (Step 116) and the process ends (Step 118).

Turning now to FIG. 8, there is shown a block diagram showing the steps involved in practicing one embodiment of this invention. In this embodiment, a varied thickness of electron-transporting material is deposited onto the different-colored pixels of an OLED substrate by first depositing a common thickness onto the pixels, and then depositing differential thicknesses of electron-transporting material onto pixels of one or more different colors. At the start (Step 120), an OLED substrate 12 has been prepared with an anode layer 40, a hole-injecting layer 42, and a hole-transporting layer 44. A first donor element 10 is placed against OLED substrate 12 (Step 122). Using the method shown in FIG. 3, a predetermined thickness of light-producing material is selectively transferred from the first donor element 10 to pixels of a first color (e.g. red) on substrate 12 by illuminating the first donor element 10 with laser light 74 so that donor element 10 absorbs light and produces heat to selectively form an emissive layer 46 of a single color between anode 40 and cathode 50 (Step 124). The first donor element 10 is then removed (Step 126). If light-producing material has not been deposited onto all the different-colored pixels (Step 128), Steps 122, 124, and 126 are repeated for the different-colored light-producing materials to form a plurality of emissive layers. If light-producing material has been deposited onto all the different-colored pixels (Step 128), a predetermined thickness of electron-transporting material is then transferred to all pixels on substrate 12 (Step 130) by any of a variety of methods, such as evaporation, sputtering, chemical vapor deposition, electrochemical means, or laser thermal transfer. A second donor element 10 is then placed against OLED substrate 12 (Step 132). A predetermined thickness of electron-transporting material is then transferred from the second donor element 10 to pixels of a single color (e.g. green) on substrate 12 by selectively illuminating the second donor element 10 with laser light 74 so that the second donor element 10 absorbs light and produces heat to selectively form an organic layer in relationship to emissive layer 46, in this case electron-transporting layer 48 above emissive layer 46 and between anode 40 and cathode 50 (Step 134). Because a common thickness of electron-transporting layer 48 was deposited in Step 130, Step 134 varies the thickness of the organic layer, that is, electron-transporting layer 48 over pixels of a single color (e.g. red). The second donor element 10 is then removed (Step 136). If a custom thickness of electron-transporting material has not been deposited onto all appropriate pixels (Step 138), Steps 132, 134, and 136 are repeated. If a custom thickness of electron-transporting material has been deposited onto all appropriate pixels (Step 138), the process ends (Step 140), after which additional layers (e.g. cathode 50) can be coated by known techniques.

Variations of this process are possible. Step 130 can be skipped and a series of donor element transfers (Steps 132, 134, and 136) can be used to form an organic layer of varying thickness. The thickness of the emissive layer 46 can be varied during the deposition of different-colored emissive layers (Steps 122, 124, and 126). The varying thickness of either the organic layer (e.g. electron-transporting layer 48) or emissive layer 46, or both, optimizes the light emission for each different-colored pixel to produce effective colors for the OLED device.

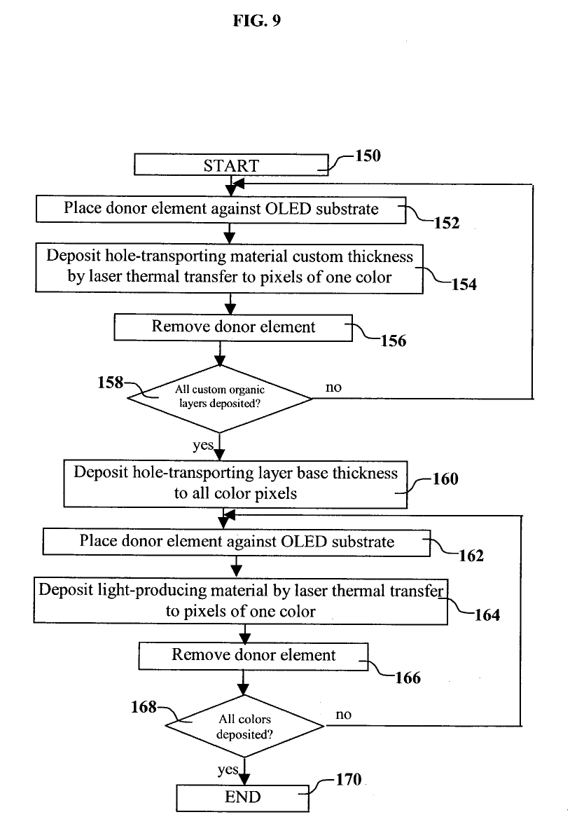

Turning now to FIG. 9, there is shown a block diagram showing the steps involved in practicing another embodiment of this invention. In this embodiment, a varied thickness of hole-transporting material is deposited onto the different-colored pixels of an OLED substrate by first depositing differential thicknesses of electron-transporting material onto pixels of one or more different colors, and then depositing a common thickness onto the pixels. At the start (Step 150), an OLED substrate 12 has been prepared with an anode layer 40 and a hole-injecting layer 42. A first donor element 10 is placed against OLED substrate 12 (Step 152). Using the method shown in FIG. 3, a predetermined thickness of hole-transporting material is transferred from the first donor element 10 to pixels of a first color (e.g. red) on substrate 12 by laser thermal transfer (Step 154). The first donor element 10 is then removed (Step 156). If a custom thickness of hole-transporting material has not been deposited onto all the appropriate different-colored pixels (Step 158), Steps 152, 154, and 156 are repeated for the different-colored pixels. If custom thicknesses of hole-transporting material has been deposited onto all appropriate different-colored pixels (Step 158), a predetermined thickness of hole-transporting material is then transferred to all pixels on substrate 12 (Step 160) by any of a variety of methods, such as evaporation, sputtering, chemical vapor deposition, electrochemical means, or laser thermal transfer. A second donor element 10 is then placed against OLED substrate 12 (Step 162). A predetermined thickness of light-producing material is then transferred from donor element 10 to pixels of a single color (e.g. red) on substrate 12 by laser thermal transfer (Step 164). The second donor element 10 is then removed (Step 166). If light-producing material has not been deposited onto all the different-colored pixels (Step 168), Steps 162, 164, and 166 are repeated. If light-producing material has been deposited onto all the different-colored pixels (Step 168), the process ends (Step 170), after which additional layers (e.g. electron-transporting layer 48 or cathode 50) can be coated by known techniques.

The invention has been described in detail with particular reference to certain preferred embodiments thereof, but it will be understood that variations and modifications can be effected within the spirit and scope of the invention.

### Parts List

10 donor element

12 substrate

14 OLED device

15 OLED device

16 donor support element

18 light-absorbing layer

20 thin-film transistor

20a thin-film transistor

20b thin-film transistor

20c thin-film transistor

22 organic material layer

24 organic material layer

26 organic material layer

30 complete organic material layer

32 complete organic material layer

34 complete organic material layer

36 organic material layer

40 anode

42 hole-injecting layer

44 hole-transporting layer

46 emissive layer

48 electron-transporting layer

50 cathode

52 color filter

54 color change module

58 light-producing material

60 organic material

62 non-transfer surface

68 raised surface portion

70 gap

72 receiving surface

74 laser light

76 laser source

78 heat

80 organic layer

100 block

102 block

104 block

106 block

108 block

110 block

112 block

114 block

116 block

118 block

120 block

122 block

124 block

126 block

128 block

130 block

132 block

134 block

136 block

138 block

140 block

150 block

152 block

154 block

156 block

158 block

160 block

162 block

164 block

166 block

168 block

170 block

What is claimed is:

1. A method of forming a colored organic light-emitting device comprising:
a) providing an anode and a cathode;
b) forming at least one emissive layer for producing a predetermined colored light between the anode and cathode;
c) forming at least one organic layer in relationship to the emissive layer by selectively transferring organic material from at least one donor element; and
d) varying the thickness of the organic layer formed in Step c) to produce effective colored light produced by the emissive layer for the organic light-emitting device.

2 The method of claim 1 wherein the organic layer(s) is another emissive layer or a hole-transporting layer or an electron-transporting layer, or a combination including such layers.

3. The method of claim 1 where the organic emissive layer comprises a dopant and a host material.

4. The method of claim 1 where the emissive layer has an emission spectrum in the blue region of the visible spectrum.

5. The method of claim 1 where the emissive layer has an emission spectrum in the green region of the visible spectrum.

6. The method of claim 1 where the emissive layer has an emission spectrum in the red region of the visible spectrum.

7. The method of claim 1 further including a color filter array disposed in operative relationship with the colored organic light-emitting device and adapted to receive colored light from the emissive layer.

8. The method of claim 1 further including a color change module disposed in operative relationship with the colored organic light-emitting device and adapted to receive colored light from the emissive layer.

9. A method of forming a colored organic light-emitting device comprising:
a) providing an anode and a cathode;
b) forming a plurality of emissive layers by selectively transferring from first donor elements different-colored light-producing materials between the anode and cathode;
c) forming at least one organic layer in relationship to the emissive layers by selectively transferring organic material from at least one second donor element; and
d) varying the thickness of the emissive layer or the organic layer(s) or both formed in Steps b) and c) for each different-colored emissive layer to produce effective colors for the organic light-emitting device.

10. The method of claim 9 wherein the one or more organic layers includes a hole-transporting layer, an electron-transporting layer, a hole-injecting layer, an electron-injecting layer, or an additional emissive layer, or combinations thereof.

11. The method of claim 9 where the organic emissive layer comprises a dopant and a host material.

12. The method of claim 9 where the light-producing material has an emission spectrum in the blue region of the visible spectrum.

13. The method of claim 9 where the light-producing material has an emission spectrum in the green region of the visible spectrum.

14. The method of claim 9 where the light-producing material has an emission spectrum in the red region of the visible spectrum.

15. The method of claim 9 further including a color filter array disposed in operative relationship with the colored organic light-emitting device and adapted to receive colored light from the emissive layer.

16. The method of claim 9 further including a color change module disposed in operative relationship with the colored organic light-emitting device and adapted to receive colored light from the emissive layer.

17. A method of forming a colored organic light-emitting device comprising:
a) providing an anode and a cathode;
b) forming a plurality of emissive layers and one or more organic layers for each emissive layer by selectively transferring from donor elements different-colored light-producing materials and organic materials between the anode and cathode; and
c) varying the thickness of the emissive layer or the organic layer(s) or both formed in Step b) corresponding to each different-colored emissive layer coated on the donor elements so that when they are transferred they will produce effective colors for the organic light-emitting device.

18. The method of claim 17 wherein the one or more organic layers includes a hole-transporting layer, an electron-transporting layer, a hole-injecting layer, an electron-injecting layer, or an additional emissive layer, or combinations thereof.

19. The method of claim 17 where the organic emissive layer comprises a dopant and a host material.

20. The method of claim 17 where the light-producing material has an emission spectrum in the blue region of the visible spectrum.

21. The method of claim 17 where the light-producing material has an emission spectrum in the green region of the visible spectrum.

22. The method of claim 17 where the light-producing material has an emission spectrum in the red region of the visible spectrum.

23. The method of claim 17 further including a color filter array disposed in operative relationship with the colored organic light-emitting device and adapted to receive colored light from the emissive layer.

24. The method of claim 17 further including a color change module disposed in operative relationship with the colored organic light-emitting device and adapted to receive colored light from the emissive layer.

25. A method of forming a colored organic light-emitting device comprising:
a) providing an anode and a cathode;
b) illuminating with laser light the first donor elements which absorb light and produce heat to selectively form a plurality of emissive layers by transferring from first donor elements different-colored light-producing materials between the anode and cathode;
c) selectively illuminating at least one second donor element to form at least one organic layer in relationship to the emissive layers by the transfer of organic material from at least one second donor element; and
d) varying the thickness of the emissive layer or the organic layer(s) or both formed in Steps b) and c) for each different-colored emissive layer to produce effective colors for the organic light-emitting device.

26. The method of claim 25 wherein the one or more organic layers includes a hole-transporting layer, an electron-transporting layer, a hole-injecting layer, an electron-injecting layer, or an additional emissive layer, or combinations thereof.

27. The method of claim 25 where the organic emissive layer comprises a dopant and a host material.

28. The method of claim 25 where the light-producing material has an emission spectrum in the blue region of the visible spectrum.

29. The method of claim 25 where the light-producing material has an emission spectrum in the green region of the visible spectrum.

30. The method of claim 25 where the light-producing material has an emission spectrum in the red region of the visible spectrum.

31. The method of claim 25 further including a color filter array disposed in operative relationship with the colored organic light-emitting device and adapted to receive colored light from the emissive layer.

32. The method of claim 25 further including a color change module disposed in operative relationship with the colored organic light-emitting device and adapted to receive colored light from the emissive layer.

33. An organic light-emitting device produced by the method of claim 1.

34. An organic light-emitting device produced by the method of claim 9.

35. An organic light-emitting device produced by the method of claim 17.

36. An organic light-emitting device produced by the method of claim 25.
